(19) United States
(12) Patent Application Publication
(10) Pub. No.: US 2022/0011727 A1
(43) Pub. Date: Jan. 13, 2022

(54) CONTROL DEVICE FOR CONTROLLING A MANUFACTURING PLANT AS WELL AS A MANUFACTURING PLANT AND METHOD

(71) Applicant: Robert Bosch GmbH, Stuttgart (DE)

(72) Inventors: Marcus Hlavac, Leonberg-Hoefingen (DE); Martin Schoepf, Stuttgart (DE); Michael Walther, Renningen (DE)

(21) Appl. No.: 17/293,714

(22) PCT Filed: Nov. 13, 2019
(86) PCT No.: PCT/EP2019/081143

§ 371 Date: May 13, 2021

(30) Foreign Application Priority Data
Dec. 5, 2018 (DE) 10 2018 221 002.0

(51) Int. Cl. G05B 13/04; G05B 13/02

(52) U.S. Cl. CPC G05B 13/041; G05B 13/0265

(57) ABSTRACT

A control device for controlling a manufacturing plant. The manufacturing plant includes at least one process station (for carrying out a manufacturing process. The manufacturing plant and/or the process station includes at least one process parameter for the purpose of regulation and/or control. The manufacturing plant and/or the process station including at least one detection device for detecting at least one process feature with the aid of a first control module and a second control module, the first control module and the second control module being designed to determine a control value and/or a model for the process parameter to regulate the manufacturing plant and/or the process station, based in each case on a machine learning algorithm and the process feature.

### FIELD

A control device for controlling a manufacturing plant is described. The manufacturing plant includes at least one process station for carrying out a manufacturing process, the manufacturing plant and/or the process station having at least one process parameter for the purpose of regulation and/or control. The manufacturing plant and/or the process station further include(s) at least one detection device for detecting a process feature. The control device includes a control module, the control module being designed to determine a control value or a model, based on a machine learning algorithm.

### BACKGROUND INFORMATION

Manufacturing plants and test systems have a wide range of uses in production, testing and measuring technology. Manufacturing plants and test systems are designed to carry out manufacturing processes and/or testing processes. A plurality of processes is frequently carried out in one overall process. These processes may be carried out by different process stations. To achieve an optimum in quality and manufacturing and/or test costs, these processes and their parameters must be regulated, set up and/or optimized. This regulation takes place, in particular, during ongoing operation. However, batch variations in the material used and/or tool wear frequently occur(s) during manufacturing and/or testing. Such changes must also be taken into account in the parameterization of the processes. Up to now, a post-regulation is carried out by an experienced user or adjuster.

German Patent Application No. DE 10 2016 206 031 A1 describes a welding assembly and a method for monitoring and regulating a welding process. The welding takes place with the aid of a welding tool, which is monitored and/or regulated by a device. Different welding process variables are determined as ascertainment variables, for example a voltage, a current intensity and/or a force. Based on these variables, a further process variable, for example a temperature, is estimated to thereby improve and/or optimize the welding process.

### SUMMARY

In accordance with an example embodiment of the present invention, a control device is provided for controlling a manufacturing plant. A manufacturing plant and a method for controlling the manufacturing plant are also provided. Preferred and/or advantageous specific example embodiments of the present invention result from the description herein and the FIGURES.

In accordance with an example embodiment of the present invention, a control device for controlling a manufacturing plant is provided. The control device is designed, for example, as a computer or a processor unit and/or a microchip unit. The manufacturing plant may be controlled, parameterized, optimized and/or set up with the aid of the control device. In particular, the control device is designed for continuous and/or initial optimization, control and/or setup of the manufacturing plant. For example, optimization is understood to be improving the manufacturing plant with respect to manufacturing quality and/or manufacturing costs. The manufacturing plant is designed to manufacture a workpiece and/or to test a workpiece. In particular, a manufacturing plant may be understood to be a test system, test steps then being understood as the manufacturing process. In particular, the manufacturing plant is a fabrication plant.

The control device may form a decentralized or a central control device. For example, the control device may be connected and/or connectable to the manufacturing plant via a data link.

In accordance with an example embodiment of the present invention, the manufacturing plant includes at least one process station. In particular, the manufacturing plant includes more than two or more than ten process stations. The process stations may be local positions and/or stations which are, for example, spatially separated. Alternatively, process stations may spatially coincide. The process stations are designed to carry out a manufacturing process. In particular, different process stations carry out different manufacturing processes. The manufacturing processes may be understood to be partial processes of the manufacturing plant and/or the manufacturing of the workpiece. For example, a manufacturing process is a machining, a heat treatment or a forming. The manufacturing processes of different process stations may take place consecutively and/or be coordinated with each other. In particular, process stations and/or manufacturing processes may engage with each other. It is furthermore possible for manufacturing processes to run in parallel.

In accordance with an example embodiment of the present invention, the manufacturing plant and/or the process station has/have at least one process parameter. In particular a process station and/or the manufacturing plant may have a plurality of process parameters. The process parameters are, in particular, settable, regulatable and/or controllable variables. The manufacturing process and/or the manufacturing plant may be controlled and/or regulated with the aid of the process parameters. For example, the speed and/or the quality of a manufacturing process and/or the entire manufacturing plant may be changed by setting and/or changing a process parameter. In particular, it is possible that the changing of a process parameter of one process station may have an effect on a further, different process station. In particular, it is sometimes possible that, by changing one process parameter, a further process parameter of the same process station or of another process station must be adjusted.

In accordance with an example embodiment of the present invention, the manufacturing plant and/or the process station include(s) at least one detection device for detecting a process feature. The process feature is, for example, a variable which characterizes the manufacturing process and/or a manufactured workpiece. The detection device may be a sensor device for detecting a physical, chemical and/or mechanical variable, which characterizes the manufacturing process and/or the workpiece. For example, the process features is a temperature or shape deviation. In particular, the process feature may also be a quality feature of the workpiece and/or the manufacturing process. It may be provided that the detection device includes an input device, with the aid of which a user may enter and/or store quality features. Quality features may originate, in particular, from a subsequent and/or downstream quality assurance of the workpiece and/or the manufacturing plant. In particular, a process station may be characterizable by multiple process features. The change and/or regulation of a process parameter preferably results in a modification of the process feature. The process parameter and process feature are thus, in particular, linked in a cause-effect relationship. If the manufacturing plant includes multiple process stations and/or multiple manufacturing processes, the multiple process parameters may be controlled and/or regulated, separate process features being preferably determined and/or determinable in each case for the different manufacturing processes and/or processing stations.

In accordance with an example embodiment of the present invention, the control device includes a first control module and a second control module. The first control module and the second control module may be encompassed by a shared computer or a shared data processing module. The first control module and the second control module may be designed as a software module or as a hardware module. In particular, the process parameters and/or the process features are provided to the first control module and the second control module. It may be provided, in particular, that the first control module and the second control module are connected to the manufacturing plant and/or the process station via a data link, for example to thereby regulate, modify and/or control the process parameters. The first control module and the second control module are designed to carry out and/or execute a machine learning algorithm. For example, the first control module and/or the second control module include(s) a neural network and/or include(s) a deep learning algorithm. In particular, the first control module and the second control module are designed in such a way that the machine learning algorithms are actively executed at different times. It is provided, in particular, that the machine learning algorithm of the first control module takes place before the machine learning algorithm of the second control module is carried out. In particular, it is provided that the second machine learning algorithm is carried out by the second control module continuously and/or in a continuous loop. The machine learning algorithm of the first control module is applied, in particular, during an initialization of and/or an addition to a fabrication.

A machine learning algorithm is understood to be, in particular, building and/or improving knowledge and/or experience with the aid of artificial intelligence. In particular, the two machine learning algorithms of the first control module and the second control module are based on different learning focuses and/or learning methods. For example, the machine learning algorithms are designed for monitored learning, for example partially monitored learning, limited learning and/or active learning. Alternatively, the machine learning algorithm may be designed for unmonitored learning.

In accordance with an example embodiment of the present invention, the first control module and/or the second control module is/are designed to determine, improve and/or optimize control values for the process parameter, based on the machine learning algorithm and, in particular, based on the process feature and/or the set process parameters. In particular, the first control module and the second control module may be designed to improve and/or optimize a model for regulating and controlling the process parameters of the process station and/or the manufacturing plant. For example, the control modules are designed to test and/or model the influence of a process parameter and/or the change in a manufacturing plant with respect to the impact on the process feature and/or the quality of the workpiece with the aid of the machine learning algorithm.

The present invention includes consideration that a manufacturing plant including a plurality of manufacturing processes and/or process parameters may be optimized and/or improved by using two control modules having two machine learning algorithms. It is thus possible to optimize even complex manufacturing plants, in which, for example, a user would easily lose track of things. For example, it is possible that the modification of a single process parameter in the beginning may affect the workpiece quality and/or a process at the very end in the manufacturing plant. Due to the monitoring, in particular in a time offset manner and/or with the aid of different machine learning algorithms, it is possible to be able to understand complex effects. For example, the local monitoring of multiple process stations may thus result in an optimization of the result.

It is preferred, in particular, that the control device includes a combination module. The combination module is designed, in particular, as a computing unit or as a computer and/or as a computing chip. In particular, the combination module, together with the first control module and the second control module, may form an evaluation module. In particular, the control value and/or the model, which was provided, determined and/or improved by the first control module and/or the second control module, is/are provided to the combination module. In particular, the updated and/or past control values and/or models are provided to the combination module in each case. In addition, the set process parameters, value ranges of the process parameters and/or process features are provided to the combination module. The combination module is designed to refine and/or determine a global model of the manufacturing plant, based on the results of the first control module and the second control module. The combination module is designed to evaluate the data, based on a machine learning algorithm. For example, the combination module uses the determined control values and/or models of the two control modules to determine inferences about comprehensive effects. For example, the global model describes correlations which could not have been detected and/or determined by the first control module and the second control module alone. The results of the global model, for example process features, effects, learning content and/or models, are provided to the first control module and/or the second control module.

This design is based on the consideration that the results of subprocesses and/or process stations in the manufacturing plant may be evaluated by a module which is also based on a machine learning algorithm. By determining the global module, comprehensive and/or other effects may be taken into account which could not have been determined by purely observing a single process parameter, a single process station or control module.

It is optionally provided that the control device includes a memory module. The memory module may be part of a computing unit. In particular, the memory module is designed as a central memory module. The memory module is connected, for example, to the first control module, the second control module and/or the combination module via a data link. The memory module is designed to store models, control values, process features and/or process parameters. In particular, the models, control values, process features and/or process parameters are provided with a time stamp and/or include further data. A chronology of the learning development, the models and/or the control values may be determined with the aid of the memory module. This design is based on the consideration that an improved machine learning algorithm and/or an improved learning success may be generated by storing data.

In particular, it is provided that the first control module is designed to determine an initial value for the process parameter as a control value.

For example, the first control module is designed to be active and to determine initial values for the process parameters when changing from one workpiece to another workpiece, during startup and/or when restarting the manufacturing plant or a process station. For example, the control module is designed to be provided with a batch, workpiece, tool and/or further data during startup or production start, and to determine initial values for the production based thereon with the aid of the machine learning algorithm.

It is particularly preferred that the first control module is designed to determine the initial value and/or the initial values for a start and/or an initialization of a fabrication, a manufacturing plant and/or a process station. The determination of the initial value is preferably based on a stored model and/or a stored control value of a previous fabrication. A previous fabrication may be an immediately preceding fabrication of an identical or different type of workpiece. Alternatively, a plurality of stored models and/or control values may be used to determine the initial values. This design is based on the consideration that experience from previous and/or past fabrications of the same or a different workpiece may be applied to the restart, and experience may be drawn therefrom with the aid of the machine learning algorithm.

One example embodiment of the present invention provides that the second control module is designed to continuously determine one or multiple control values and/or one model for the manufacturing plant and/or for the process station and/or for the process stations. It is provided, in particular, that the control value determination and/or the model determination is/are carried out by the second control module from one manufactured workpiece to another manufactured workpiece. Alternatively and/or additionally, the determination of the control value and/or the model by the second control module may take place cyclically with regard to time, for example at equidistant time intervals. It is preferably provided that the first control module is carried out at the beginning of a fabrication and/or upon startup of the manufacturing plant, and the second control module is and/or becomes subsequently active. This design is based on the consideration that an initialized machine learning application is carried out with the aid of the first control module and a continuous one with the aid of the second control module.

One example design of the present invention provides that the control device includes an interface module. For example, the interface module is designed as an input and output device. For example, the interface module is a touchscreen unit. The interface module is designed, for example to display data, images and/or videos. It is further provided that the interface module is designed, in particular, to enable a user to enter data thereon, for example to reject or accept something. The interface module is designed, in particular, to suggest and/or to display to the user the control value and/or a module, for example which was displayed by the first control module or the second control module. The user may accept or reject this control value, for example unlimited with regard to time or within a fixed time frame. This design is based on the consideration that a human or specialized person continues to monitor the control of the manufacturing plant and may, if necessary, intervene in a supporting and/or helping manner.

It is preferred, in particular, that the process feature includes a quality feature of a workpiece and/or an intermediate product. The workpiece is, for example, the manufactured workpiece of the manufacturing plant. An intermediate product is a precursor or an initial object in the manufacture of the workpiece. For example, the shape, material properties and/or other physical/chemical variables of the object may be used as the quality feature. The quality features may have been determined and/or detected by a sensor during the fabrication and/or during the manufacturing process. Alternatively, it may be provided that the quality features are stored and/or added by a user and/or a laboratory as a data set, for example in the memory module. The quality features may therefore also originate from a downstream quality control and be incorporated by the control module offset with regard to time.

It is preferred, in particular, that the process feature forms and/or describes a physical and/or chemical property. In particular, the process feature describes a batch material feature. For example, the process feature may describe the composition and/or the quality of the batch material. It is further provided, for example, that the process feature describes a property of the workpiece, the intermediate product and/or the tool. In particular, the property of the tool may describe a wear, a temperature or a performance of the tool. This design is based on the consideration that the first control module and/or the second control module may take into account batch variations, workpiece qualities and/or tool qualities during the determination of the control values and/or the model.

It is optionally provided that the first control module is designed to base a model, a simulation and/or a prediction on the machine learning algorithm or to incorporate it/them thereinto. For example, the model may represent a modeling of the manufacturing plant or the manufacturing process. The model may further be, for example, a plan to carry out the fabrication, which is predefined by a user or an adjuster. For example, assumptions may be construed as predictions, which were stored and/or entered by a user or an adjuster. This design is based on the consideration that the first control module, which describes, in particular, an initialization of the manufacturing plant, is able to build on an expanded data set.

In particular, the combination module is designed to facilitate, carry out and/or enable a data exchange, a model exchange, a knowledge exchange and/or a parameter exchange between the first control module and the second control module. For example, the combination module is designed to query and/or receive data, models, knowledge and/or parameters from the first control module and to provide them to the second control module. The same principle is also possible by a request from the second control module and for forwarding to the first control module. In particular, the facilitation and/or the exchange between the first control module and the second control module takes place via the combination module in a filtered manner, so that, for example, only data, models, knowledge and/or parameters are exchanged which are needed.

It is optionally provided that the combination module is designed to carry out a knowledge reduction and/or a sensitivity analysis before and/or during an exchange of data, models, knowledge and/or parameters between the first and second control modules. This design is based on the consideration that an overtraining and/or a needless multiple knowledge does not occur. An efficient and narrow control unit may thus be generated.

Another object of the present invention is a manufacturing plant. In accordance with an example embodiment of the present invention, the manufacturing plant includes at least one process station for carrying out a manufacturing process, the process station and/or the manufacturing plant including at least one process parameter for the purpose of regulation and/or control. The manufacturing plant includes a control device, in particular a control device as described above. The control device includes a first control module and a second control module. The first control module and the second control module are designed to determine a model and/or a control value for the manufacturing plant in an offset manner with regard to time, based on a machine learning algorithm, and, in particular, to set and/or control the manufacturing plant, based on the control value and/or the model.

It is particularly preferred that the manufacturing plant includes a plurality of process stations. In particular, it may be provided that the manufacturing plant includes a plurality of second control modules, the second control modules each being designed to control, monitor and/or determine control values of a different process station. A combination module, which is encompassed by the control device, may, for example, link the plurality of second control modules and contribute to a data exchange. This design is based on the consideration that a manufacturing plant including a plurality of process stations is evaluated and/or monitored by a plurality of control modules, which are based on a machine learning algorithm, the obtained control values and/or models being subsequently combined and possibly further evaluated with the aid of a combination module.

A further object of the present invention is a method for controlling a manufacturing plant, which includes a plurality of process stations. The method provides that the manufacturing plant and/or the process stations is/are monitored, evaluated and/or controlled, based on two machine learning algorithms. The machine learning algorithms are carried out, in particular offset with regard to time, and/or have different learning focuses. In particular, it is provided that a further machine learning algorithm may access the results, for example control values and/or models, of the other two machine learning algorithms and may prepare more global statements and/or models based on their results.

Further advantages, effects and example embodiments of the present invention result from the FIGURE and its description herein.

### BRIEF DESCRIPTION OF THE DRAWINGS

FIG. 1 schematically shows an exemplary embodiment of a manufacturing plant.

### DETAILED DESCRIPTION OF EXAMPLE EMBODIMENTS

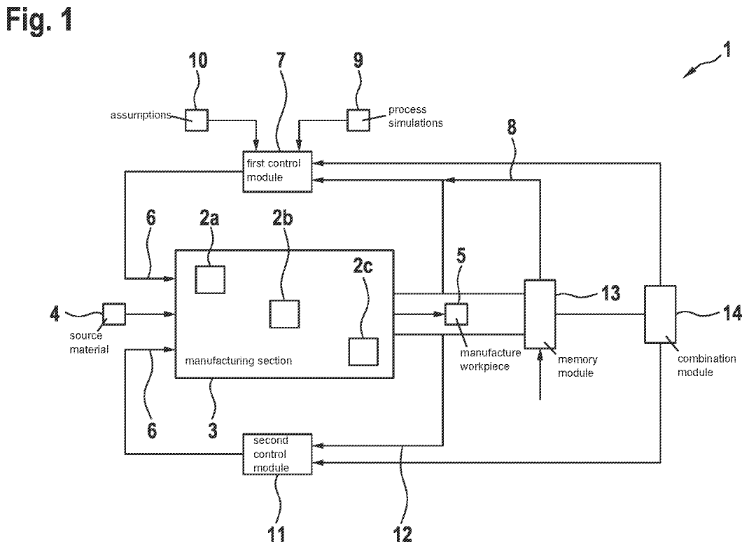

FIG. 1 schematically shows an exemplary embodiment of a manufacturing plant 1 in accordance with the present invention.

Manufacturing plant 1 includes a plurality of process stations 2a, 2b and 2c. Process stations 2a, 2b and 2c are, for example, process stations in a manufacturing section 3, which represents a section of a factory floor. Process stations 2a, 2b and 2c are designed to carry out a manufacturing method. For example, they are designed for drilling, cutting, thermal treatment. In particular, process stations 2a, 2b, 2c form chained production methods. A workpiece 5 is formed from a source material 4 with the aid of manufacturing plant 1 and/or process stations 2a, 2b, 2c. Source material 4 is dependent on a batch material and thus subjected to product and/or material variations. Process stations 2a, 2b, 2c may be equipped with a tool, which is designed to process material and to manufacture workpiece 5.

Manufacturing plant 1 and/or process stations 2a, 2b, 2c include process parameters 6, with the aid of which process stations 2a, 2b, 2c and/or manufacturing plant 1 may be controlled and/or set. The quality and/or type of workpiece 5 may be influenced by varying process parameters 6.

Manufacturing plant 1 includes a first control module 7. Information and/or data from previous processes, for example fabrications of workpieces 5, may be provided to first control module 7 as predecessor data 8. Process simulations 9 and assumptions 10 may also be provided to first control module 7. Process simulations 9 and/or assumptions 10 may be provided by a computer program or an operator. Information and/or data about the workpiece material, the tool used, the instantaneous process and/or further physical/chemical information on operations may be further provided to control module 7. First control module 7 is designed to carry out a machine learning algorithm. Based on this machine learning algorithm, a model-based learning algorithm is carried out, so that process parameters may be established, and control values may be output.

In particular, the model-based determination and/or the machine learning algorithm take(s) place for ascertaining physical and/or chemical cause/effect relationships of manufacturing plant 1. A model and/or learned knowledge may be continuously improved and analysis algorithms possibly refined by using information from previous fabrications and/or processes. With the aid of first control module 7, it is thus possible to be able to identify process-internal and/or comprehensive interactions and to possibly be able to minimize negative effects on the quality faster. Initial values and/or parameters, with the aid of which the manufacturing plant may be operated to produce workpiece 5 may thus be established with the aid of first control module 7. Control module 7 may be designed to be able to set the manufacturing plant with the aid of process parameters 6, based on the determined values, parameters, control values and/or models.

Manufacturing plant 1 includes a second control module 11. Second control module 11 is designed to carry out a machine learning algorithm. Process parameters and/or process features 12 are provided to second control module 11. Based on the process features and the machine learning algorithm, second control module 11 is designed to continuously adjust the process parameters and determine, for example, control values for these process parameters 6. In particular, control module 11 may be designed to determine and/or refine a model, which describes the cause and effect of varying process parameters on the process features. Second control module 11 is preferably designed to monitor each process station separately or alternatively to monitor combinations of process stations with the aid of the machine learning algorithm.

Manufacturing plant 1 includes a memory module 13. The control values, the model and/or the process parameters of first control module 7, second control module 11 and/or process stations 2a, 2b, 2c are provided to memory module 13. They are stored there in a central manner. External data may further be provided to memory module 13, for example from a subsequent quality assurance, which is carried out, in particular, externally. The data and/or subsets of the data in memory module 13 are provided, in particular, to first control module 7 and second control module 11.

Manufacturing plant 1 includes a combination module 14. Combination module 14 is designed to enable a data exchange between first control module 7 and second control module 11. In particular, combination module 14 is designed to test the results of the first control module and the second control module and, for example, to extract correlations such as cause/effect principles. With the aid of combination module 14, it is therefore possible to determine independent learning via operating principle correlations between the two determined models of the first control module and the second control module. It may further be provided that combination module 14 is designed for a knowledge reduction and carries out, for example, a sensitivity analysis for this purpose. The avoidance of overtraining and multiple expertise in the first control module and the second control module is thus reduced.

In particular, the present invention is based on the consideration that first control module 7 determines optimal parameters for the process of process station 2a, 2b and/or 2c, control module 11 continuously adapting these parameters according to instantaneous conditions during the course of the process. First control module 7 is designed for static design and/or optimization, the second control module carrying out a dynamic optimization.

1-15. (canceled)

16. A control device for controlling a manufacturing plant, the manufacturing plant including at least one process station configured to carry out a manufacturing process, the manufacturing plant and/or the process station including at least one process parameter for regulation and/or control, the manufacturing plant and/or the process station including at least one detection device configured to detect at least one process feature, the control device comprising:
a first control module and a second control module, the first control module and the second control module being configured to determine a control value and/or a model for the process parameter, for regulating the manufacturing plant and/or the process station, based in each case on a machine learning algorithm and the process feature.

17. The control device as recited in claim 16, further comprising:
a combination module, the control value and/or the model of the first control module and the second control module being provided to the combination module, the combination module being configured to refine and/or determine a global model of the manufacturing plant, based on a machine learning algorithm, the combination module being configured to provide the global model to the first control module and/or the second control module.

18. The control device as recited in claim 16, further comprising:
a memory module configured to store determined models and/or control values.

19. The control device as recited in claim 16, wherein the first control module is configured to determine an initial value for the process parameter as the control value.

20. The control device as recited in claim 19, wherein the first control module is configured to determine the initial value for a startup of a fabrication, the determination of the initial value being based on a stored model and/or control value of a previous fabrication.

21. The control device as recited in claim 16, wherein the second control module is configured to continuously determine the control value and/or the model for the manufacturing plant and/or the process station.

22. The control device as recited in claim 16, further comprising:
an interface module configured to provide the control value of the first control module and/or second control module to a user for confirmation.

23. The control device as recited in claim 16, wherein the process feature includes a quality feature of a workpiece and/or an intermediate product.

24. The control device as recited in claim 16, wherein the process feature includes a physical and/or chemical property of: a batch material, and/or a workpiece, and/or an intermediate product, and/or a tool.

25. The control device as recited in claim 16, wherein the first control module is configured to base the model, and/or a simulation and/or predictions on the machine learning module.

26. The control device as recited in claim 17, wherein the combination module is configured to facilitate a data exchange, and/or a model exchange, and/or a knowledge exchange, and/or a parameter exchange, between the first control module and the second control module.

27. The control device as recited in claim 17, wherein the combination module is configured for a knowledge reduction and/or a sensitivity analysis for the model and/or the control value of the first control device and/or the second control device.

28. A manufacturing plant, comprising:
at least one process station, wherein the manufacturing plant and/or the process station include at least one process parameter for regulation and/or control, and the manufacturing plant and/or the process station includes at least one detection device configured to detect at least one process feature; and
a control assembly configured to regulate the manufacturing plant, the control device assembly including:
a first control module and a second control module, the first control module and the second control module being configured to determine a control value and/or a model for the process parameter, for regulating the manufacturing plant and/or the process station, based in each case on a machine learning algorithm and the process feature.

29. The manufacturing plant as recited in claim 23, wherein the at least one process station includes more than two process stations.

30. A method for controlling a manufacturing plant, the manufacturing plant including a plurality of process stations, the method comprising:
monitoring the manufacturing plant and/or the process stations, by a first control module and a second control module, based on two machine learning algorithms.
